(19) United States
(12) Patent Application Publication
(10) Pub. No.: US 2006/0091649 A1
(43) Pub. Date: May 4, 2006

(54) Airbag and airbag device

(75) Inventors: Masayoshi Kumagai, Ika-gun (JP); Kazuhiro Abe, Berlin (DE)

Correspondence Address: KANESAKA BERNER AND PARTNERS LLP, SUITE 300, 1700 DIAGONAL RD, ALEXANDRIA, VA, 22314-2848, US

(73) Assignee: TAKATA CORPORATION, Tokyo (JP)

(21) Appl. No.: 11/237,790

(22) Filed: Sep. 29, 2005

(30) Foreign Application Priority Data
Oct. 22, 2004 (JP) 2004-308351

(51) Int. Cl. B60R 21/16

(52) U.S. Cl. 280/729

(57) ABSTRACT

An airbag is partitioned into a first chamber and a second chamber, not having significant irregularities or partial protrusions on the front surface thereof (front panel) during the expansion, and is capable of catching an occupant in a substantially even manner at the front surface thereof. The airbag is formed by connecting a front panel and a rear panel by a first seam. An inner panel is disposed inside the airbag. The inner panel has communicating holes and inner vent holes. The inner periphery of the inner panel is connected to the front panel by a second seam. When the airbag is flattened, the ratio C₁/C₂ of a perimeter C₁ of the second seam to a perimeter C₂ of the first seam ranges from about 0.35 to about 0.8.

### BACKGROUND OF THE INVENTION AND RELATED ART STATEMENT

The present invention relates to airbags preferably installed in steering wheels of vehicles and protecting human bodies by expanding in emergency situations such as collisions.

Various airbag devices such as driver's airbag devices are used for protecting occupants of vehicles in emergency situations such as collisions. A driver's airbag device includes an airbag formed by stitching together peripheries of a front panel adjacent to an occupant and a rear panel remote from the occupant. An opening for engaging an inflator is formed in the center of the rear panel such that the front end of the inflator is fitted therein. The rear panel is fixed to a retainer with bolts, pins, or rivets placed around the opening. The rear panel has vent holes for letting out a gas inside the airbag so as to absorb a shock caused when the occupant bumps into the airbag.

Japanese Unexamined Patent Application Publication Nos. 1-311930 and 10-81191 disclose an airbag partitioned into a first chamber in the center and a second chamber surrounding the first chamber by an inner panel (referred to as an “inner gas bag” in Japanese Unexamined Patent Application Publication No. 1-311930) extending from the opening of the rear panel to the front panel. Communicating holes that connect the first chamber and the second chamber are formed in this inner gas bag. When the inflator is activated, the first chamber first expands, and then the second chamber expands.

The object of the present invention is to provide an airbag, partitioned into a first chamber and a second chamber by an inner panel connected to the front panel as above, not having significant irregularities on the front surface of the front panel during the expansion, and capable of catching the occupant in a substantially even manner at the front surface thereof.

### SUMMARY OF THE INVENTION

In order to attain the objects described above, according to a first aspect of the invention, an airbag inflated by a gas from a gas generator includes a front panel disposed adjacent to an occupant and a rear panel disposed remote from the occupant. The peripheries of the front panel and the rear panel are connected to each other. A first opening for the gas generator is formed in the center of the rear panel. An inner panel partitions the interior of the airbag into a first chamber in the center and a second chamber surrounding the first chamber. And, a second opening is formed in the center of the inner panel and being substantially concentric with the first opening of the rear panel. The periphery of the inner panel adjacent to the front end is connected to an intermediate portion between the center and the periphery of the front panel. A ratio C₁/C₂ of a perimeter C₁ of a connecting portion of the periphery of the inner panel adjacent to the front end and the front panel to a perimeter C₂ of a connecting portion of the front panel and the rear panel ranges from about 0.35 to about 0.8, when the airbag is flattened.

According to another aspect, the inner panel comprises a first inner panel adjacent to the front panel and a second inner panel adjacent to the rear panel, and the rear end of the first inner panel is connected to the front end of the second inner panel.

According to a further aspect, the gas generator has a gas port where at least the front end of the gas generator is disposed inside the airbag, and the gas port is disposed inside the airbag.

According to the airbag and the airbag device of the present invention, when the airbag is flattened, the ratio C₁/C₂ of the perimeter C₁ of the connecting portion of the front panel and the inner panel to the perimeter C₂ of the connecting portion of the front panel and the rear panel ranges from about 0.35 to about 0.8. Accordingly, when the airbag is inflated, the airbag does not have significant irregularities or partial protrusions on the front surface thereof, and can evenly catch the occupant in a wide area of the front surface thereof.

Further, the inner panel comprises the first inner panel adjacent to the front panel, and the second inner panel adjacent to the rear panel, where the first and second inner panels are connected to each other. Therefore, the thickness or the shape of the airbag can easily be adjusted by adjusting the size of the first inner panel.

### BRIEF DESCRIPTION OF THE DRAWINGS

FIG. 1 is a cross-sectional view of an airbag and an airbag device according to an embodiment;

FIG. 2 is an exploded perspective view of the airbag and the airbag device shown in FIG. 1;

FIG. 3 is a plan view of the flattened airbag; and

FIGS. 4(a) and 4(b) are cross-sectional views according to the comparative examples.

### DETAILED DESCRIPTION OF PREFERRED EMBODIMENTS

An embodiment of the present invention will now be described with reference to the drawings.

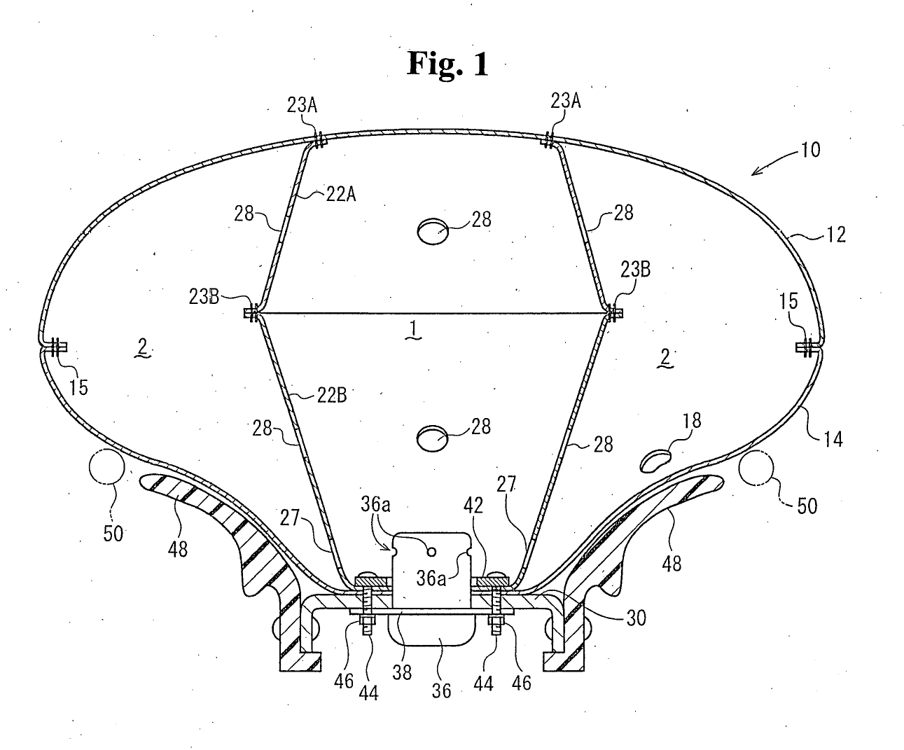

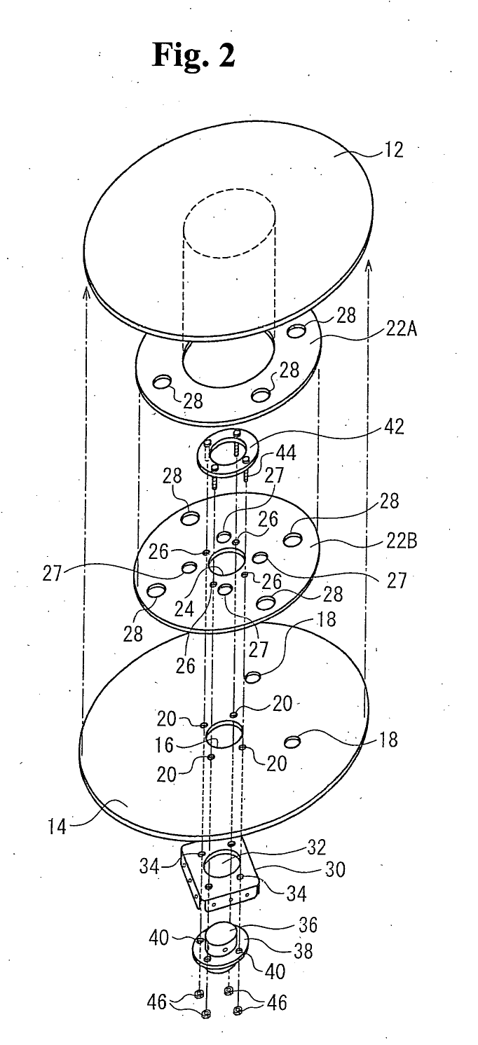

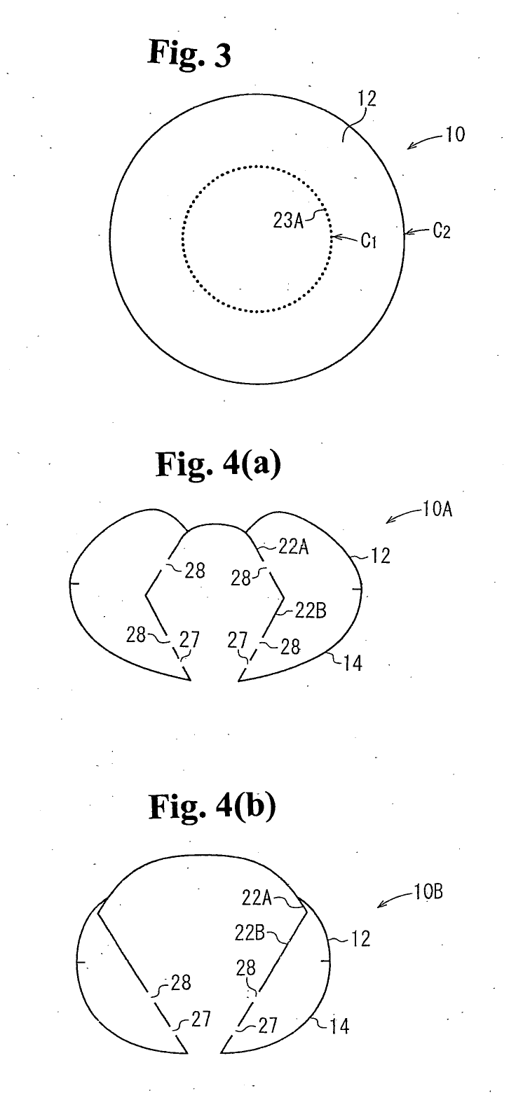

FIG. 1 is a cross-sectional view of a driver's airbag and an airbag device of a vehicle according to an embodiment of the present invention. FIG. 2 is an exploded perspective view of the airbag and the airbag device. FIG. 3 is a plan view of the flattened airbag. And, FIGS. 4(a) and 4(b) are schematic views illustrating comparative examples.

Airbag 10 includes a front panel 12, a rear panel 14, a first inner panel 22A, and a second inner panel 22B formed of substantially circular fabrics. The front panel 12 and the rear panel 14 have the same diameter, and are stitched together with a seam 15 of a thread or the like at the outer peripheries thereof so as to form a bag. The stitched portion forms an annular ring along the outer peripheries of the front panel 12 and the rear panel 14.

The rear panel 14 includes a first opening 16 for an inflator (gas generator) and vent holes 18. This first opening 16 is disposed in the center of the rear panel 14. Bolt holes 20 are formed around the first opening 16.

The first inner panel 22A and the second inner panel 22B are disposed inside the airbag 10. The first and second inner panels 22A and 22B are arranged in a substantially concentric manner with the front panel 12 and the rear panel 14, and are stitched together with a seam 23B of a thread or the like at the outer peripheries thereof. The inner periphery of the first inner panel 22A adjacent to the front panel 12 (periphery adjacent to the front end of the first inner panel 22A when the airbag 10 is inflated) is stitched on an intermediate portion between the center and the periphery of the front panel 12 with a seam 23A of a thread or the like.

A second opening 24 for the inflator arranged in a substantially concentric manner with the first opening 16 of the rear panel 14 is formed in the center of the second inner panel 22B adjacent to the rear panel 14 (portion adjacent to the rear end of the second inner panel 22B when the airbag 10 is inflated). These openings 16 and 24 are substantially circular. In addition, bolt holes 26 are formed around the second opening 24 of the second inner panel 22B, the bolt holes 26 are superposed on the bolt holes 20 of the rear panel 14.

The first inner panel 22A includes a plurality of inner vent holes 28. In the second inner panel 22B, the inner vent holes 28 are formed relatively adjacent to the outer periphery, and communicating holes 27 are formed at inner positions compared with the inner vent holes 28. The inner vent holes 28 may be formed only in any one of the first and second inner panels 22A and 22B.

The interior of the airbag 10 is partitioned into a first chamber 1 in the center and a second chamber 2 surrounding the first chamber 1 by these first and second inner panels 22A and 22B. The first chamber 1 corresponds to the interior of the first and second inner panels 22A and 22B.

The communicating holes 27 are formed on the extensions of directions along which a gas blows out of an inflator 36 (described below) disposed inside the first chamber 1 via the openings 16 and 24, i.e. at positions facing gas ports 36a of the inflator 36.

In this embodiment, as shown in FIG. 2, four communicating holes 27 and four inner vent holes 28 are formed in the circumferential direction of the airbag at regular intervals. Furthermore, the phases of the communicating holes 27 and the inner vent holes 28 are shifted in the circumferential direction with respect to the center of the airbag.

Reinforcing patches may be attached to the peripheral portions of the openings 16 and 24, and the vent holes 18 and 28.

A retainer 30 on which the airbag 10 is mounted has an attachment hole 32 for the inflator in the center, and bolt holes 34 around the attachment hole 32.

The inflator 36 is substantially cylindrical, and has the gas ports 36a in the circumferential surface adjacent to the front end in the axial direction of the cylinder. In this embodiment, four gas ports 36a are formed in the inflator 36 in the circumferential direction at regular intervals. The inflator 36 blows a gas out of these gas ports 36a in the radial direction. A flange 38 for fixing the inflator protrudes from the circumferential surface of the inflator 36 at a predetermined position in the axial direction (closer to the rear end than the gas ports 36a). The flange 38 has bolt holes 40. A front-end portion of the inflator 36 is fitted into the attachment hole 32 of the retainer 30.

Before the airbag 10 is mounted on the retainer 30, the periphery of the second opening 24 of the second inner panel 22B is superposed on the first opening 16 of the rear panel 14, which subsequently is superposed on the attachment hole 32 of the retainer 30.

Then, stud bolts 44 of a retaining ring 42 are fitted into the bolt holes 26, 20, 34, and 40 of the second inner panel 22B, the rear panel 14, the retainer 30 and the flange 38, respectively, and nuts 46 are attached to the ends of the stud bolts 44. Thus, the second inner panel 22B, the airbag 10, and the inflator 36 are fixed to the retainer 30. Subsequently, the airbag 10 is folded, and a module cover 48 is fixed to the retainer 30 so as to cover the folded airbag. In this manner, an airbag device is produced. This airbag device is installed in a steering wheel 50 of a vehicle.

With reference to FIG. 3, when the airbag before expansion is flattened, the perimeter of the seam 23A connecting the front panel 12 and the first inner panel 22A is defined as C₁, and the perimeter of the seam 15 connecting the front panel 12 and the rear panel 14 is defined as C₂. The ratio C₁/C₂ ranges from about 0.35 to about 0.8, preferably from about 0.4 to about 0.7, and more preferably from about 0.45 to about 0.65.

When a vehicle with the airbag device having the above-described structure is involved in, for example, a collision, the inflator 36 is activated and the gas blows into the airbag 10. The airbag 10 inflated by this gas pushes open the module cover 48, and is unfolded in the vehicle cabin.

When an occupant bumps into the inflated airbag 10, the gas inside the first chamber 1 and the second chamber 2 flows out via the inner vent holes 28 or the vent holes 18 so as to absorb the shock.

At this time, since the ratio C₁/C₂ ranges from about 0.35 to about 0.8, the inflated airbag 10 does not have significant irregularities on the front surface thereof (surface of the front panel 12 facing the occupant).

With reference to FIG. 4(a), when the ratio C₁/C₂ of an airbag 10A is less than about 0.35, the second chamber 2 protrudes toward the occupant during the expansion, and causes significant irregularities on the front surface. On the other hand, with reference to FIG. 4(b), when the ratio C₁/C₂ of an airbag 10B is more than about 0.8, the central portion of the front surface partially protrudes toward the occupant during the expansion. In contrast, when the ratio C₁/C₂ ranges from about 0.35 to about 0.8, the airbag 10 exhibits an approximately elliptical cross section having a smooth continuous front surface with a large radius of curvature as shown in FIG. 1. Therefore, the airbag 10 can catch the occupant in a substantially even manner in a wide area of the front surface thereof.

According to the airbag 10, the communicating holes 27 connecting the first chamber 1 with the second chamber 2 are disposed on the extensions of the gas-blowing directions of the inflator 36 disposed inside the first chamber 1, i.e. at the positions facing the gas ports 36a of the inflator 36. Therefore, when the inflator 36 is activated, the gas blows out of the gas ports 36a toward the communicating holes 27. Accordingly, as shown in FIG. 1, the gas from the inflator 36 is directly supplied also to the second chamber 2 via the communicating holes 27. As a result, the second chamber 2 can be quickly inflated.

Further, the present invention, guiding panels for guiding the gas from the inflator to the communicating holes 27 may be disposed inside the first chamber 1.

The above-described embodiment is an example of the present invention, however, the present invention is not limited to the above-described embodiment. For example, in the above-described embodiment, four gas ports 36a and four communicating holes 27 are formed. However, the number is not limited to four. Also, in the above-described embodiment, the communicating holes 27 are formed on the extensions of the gas-blowing directions of all the gas ports 36a of the inflator 36. However, the communicating holes 27 may be formed on the extensions of the gas-blowing directions of only some of the gas ports 36a. In addition, some of the communicating holes 27 may be formed out of the extensions of the gas ports 36a, and may not face the gas ports 36a. Thus, the above explanation is illustrative and the invention is limited only by the appended claims.

The disclosure of Japanese Patent application No. 2004-308351 filed on Oct. 22, 2004 is incorporated herein.

While the invention has been explained with reference to the specific embodiments of the invention, the explanation is illustrative, and the invention is limited only by appended claims.

What is claimed is:

1. An airbag inflated by a gas from a gas generator, comprising:
a front panel disposed adjacent to an occupant, and a rear panel disposed remote from the occupant and having a first opening for the gas generator formed in a center thereof, said front and rear panels having peripheries connected together; and
an inner panel for partitioning an interior of the airbag into a first chamber in a center and a second chamber surrounding the first chamber, said inner panel having a second opening formed in a center thereof substantially concentrically with the first opening of the rear panel, and a periphery connected to an intermediate portion between a center and the periphery of the front panel;
wherein a ratio C₁/C₂ of a perimeter C₁ of a connecting portion between the periphery of the inner panel and the front panel to a perimeter C₂ of a connecting portion between the front panel and the rear panel ranges from about 0.35 to about 0.8 when the airbag is flattened.

2. The airbag according to claim 1, wherein the inner panel comprises a first inner panel adjacent to the front panel and a second inner panel adjacent to the rear panel, a rear end of the first inner panel being connected to a front end of the second inner panel.

3. The airbag according to claim 2, wherein the ratio C₁/C₂ ranges from about 0.4 to about 0.7.

4. The airbag according to claim 2, wherein the ratio C₁/C₂ ranges from about 0.45 to about 0.65.

5. The airbag according to claim 2, wherein said inner panel further includes a plurality of communicating holes for communicating the first chamber to the second chamber.

6. The airbag according to claim 5, wherein the communicating holes are disposed at positions facing the gas port.

7. The airbag according to claim 2, wherein the inner panel further comprises a vent hole connecting the first chamber to the second chamber.

8. The airbag according to claim 7, wherein the rear panel further comprises a vent hole opening to atmosphere.

9. An airbag device, comprising the airbag according to claim 1 and a gas generator having a gas port, wherein at least a front end of the gas generator is disposed inside the airbag, and the gas port is disposed inside the airbag.

10. The airbag device according to claim 9, further comprising a retainer on which the airbag and the gas generator are mounted; and a module cover fixed to the retainer to cover a folded airbag.
